(19) United States
(12) Patent Application Publication
(10) Pub. No.: US 2010/0057516 A1
(43) Pub. Date: Mar. 4, 2010

(54) SYSTEM AND METHOD FOR SHARING A CALENDAR OVER MULTIPLE GEO-POLITICAL REGIONS

(76) Inventor: Rami Goraly, Jerusalem (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(21) Appl. No.: 12/524,162

(22) PCT Filed: Mar. 22, 2007
(86) PCT No.: PCT/IL2007/000384

§ 371 Date: Jul. 23, 2009

(51) Int. Cl. G06Q 10/00; G06Q 50/00; G06F 3/048

(52) U.S. Cl. 705/8; 715/764

(57) ABSTRACT

A method of displaying a computerized calendar according to different geo-political regions that takes into account time differences between the geo-political regions, wherein the time differences include differences in start date and end date of implementing daylight saving time in the geo-political region, and differences in the time zone of the geo-political region; and displaying the transformed display.

### FIELD OF THE INVENTION

The present invention relates generally to a computerized sharable calendar system that takes into account time differences between different geo-political regions.

### BACKGROUND OF THE INVENTION

The emergence of the personal computer, networking and the Internet that has taken place in the last decade has brought with it a major transition in the role of the calendar and the way in which people use it. Prior to this computerized era, calendars were typically maintained in paper or drawing format and were used mainly for listing events. These calendars were static and sharing them was cumbersome. When people wanted to schedule a meeting they would work out the details between them with minimal visibility to each party's calendar. Thus the calendar was mainly a tool for independent use.

The proliferation of personal computers, networking and the internet has opened up the possibility to easily share calendars and has transformed the role of the calendar from an independent tool to a collaborative tool that is constantly shared with different people for the purpose of scheduling. It is important to understand that when calendars are used for scheduling they are being shared in a master-slave relationship. This means that the person that is initiating the scheduling has the master calendar and the person/s that is/are responding to the scheduling have the slave calendars. It is also important to mention that calendar sharing does not mean that the entire calendar is shared. Sharing can take place on any portion of a calendar as big as the entire calendar and as small as one hour.

Calendar sharing can be considered the activity of exposing portions of a calendar, or views, in a master-slave relationship. For calendar sharing to be accurate there is one important rule that must always be maintained—That is, the number of hours in the slave view must be identical to the number of hours in the master calendar view. This rule is easy to achieve when all parties are in one geo-political region—(i.e. a region that implements the same daylight saving rules).

Nowadays it is common to schedule virtual meetings, wherein the participants do not gather at a common location, but instead each participant is located in their own geo-political region (with different daylight saving rules), and the meeting is conducted over a communication medium, for example in the form of a telephone conference, a video conference or a web conference. When one or more of the participants of the meeting are located in different geo-political regions the simple sharing of calendars may not work; as one geo-political region may have a day with only 23 hours when starting daylight saving time (DST) or a day with 25 hours when ending DST.

When parties are located in geo-political regions that differ in their DST implementation, simple calendar sharing does not adjust between the master and slave calendar views. This can cause a meeting to be scheduled at a time that does not exist for a certain party (due to DST starting) or at a time that is wrong for another party (due to DST ending). To better consider the practical aspects of this problem we can look at the date ranges for the DST start and DST end dates for the year 2007. In this year most geo-political regions in the developed countries will start daylight saving time from March 11 to March 25. Additionally, most geo-political regions in the developed countries will end daylight saving time from October 28 to November 4. As a result, for 3-4 weeks out of the 52 weeks of the year (approximately 7% of the time) most of the geo-political regions in the developed countries will be out of sync with each other. When we take into account all geo-political regions worldwide the problem is much worse. In 2007 for example, DST transitions will take place from February 25 to May 6 and then from August 6 to November 4. Thus, there will be a period of more than five months (more than 40% of the time) in which geo-political regions are out of sync relative to each other.

Despite the scheduling errors that take place when scheduling across geo-political regions, none of the computerized calendar platforms available today support calendar sharing across different geo-political regions. Some computer applications provide platforms for scheduling meetings. In some applications an organizer provides the invited participants with possible dates and times for conducting the meeting. In some applications the program allows the organizer to view the invitee calendars to determine which times are optimal to schedule the meeting. However, in all the cases there remains the problem that the slave calendar view is not adjusted for the differences in DST rules between the master and slave region.

Microsoft Exchange™ coupled with Outlook clients offers a basic computerized scheduling system, which can be implemented between members of a domain, for example over the Internet or over an intranet. In some cases the organizer can view the calendars of the invitees to verify that the times suggested for a meeting are recorded as available by the invitee. However, as described above there is no provision for amending the calendar view for invitees in different geo-political regions.

### SUMMARY OF THE INVENTION

An aspect of an embodiment of the invention, relates to a system and method for displaying a time block representing a segment of time of a specific number of hours with or without scheduled events as recorded in a calendar, according to the time zone and daylight saving time of a master geo-political region. Optionally, the system transforms the time block of the master calendar to display the same segment of time and optional events according to the time in a slave geo-political region.

In an exemplary embodiment of the invention, the system displays for a user, the time block of a master calendar according to the time and date in the master geo-political region. Optionally, the user can record events and/or view the schedule shown by the time block. In an exemplary embodiment of the invention, the user or other users can then view a slave calendar time block with exactly the same number of hours as exists in the master calendar time block converted according to the differences in time zone and DST implementation between the master and slave geo-political regions, so that for example a user in a different country can view the slave time block display and optional scheduled events adjusted to the time zone and DST implementation differences between respective geo-political regions. Alternatively, the same user can view the slave calendar time block display and optional events according to the times and dates in other countries or places, which differ from the master geo-political region.

In some embodiments of the invention, the time block represents a continuous number of days including all 24 hours of the day. Alternatively, the time block may form a window over specific hours of the day for a continuous number of days. In addition, the content of the time block can be displayed as a single horizontal line instead of a two-dimensional block.

There is thus provided according to an exemplary embodiment of the invention, a method of displaying a computerized calendar according to different geo-political regions, comprising: selecting a master geo-political region as a base for the display of the contents of the calendar, defining a time block that serves as a window for viewing the contents of the calendar; wherein the time block is defined by a selected number of days, a specific number of hours per day, and a start time per day, retrieving the contents of the calendar for the time defined by the time block starting from a selected date, selecting a slave geo-political region for displaying the contents of the calendar according to it, planning the display of the time block according to the master geo-political region, transforming the planned time block display according to the slave geo-political region; wherein the transformation takes into account clock differences between the master geo-political region and the slave geo-political region, which include differences in start date and end date of implementing daylight saving time in the geo-political region, and differences in the time zone of the geo-political region; and displaying the transformed display.

In some embodiments of the invention, the time block is displayed according to the master geo-political region and the slave geo-political region on the same display simultaneously. Optionally, a single user can view the time block according to multiple regions. In some embodiments of the invention, each user is displayed the time block only according to a region associated with the user. In an exemplary embodiment of the invention, the transformed display shows the same number of hours as the planned master display. In some embodiments of the invention, daylight saving time adjustments in the master geo-political region occur during the time covered by the defined time block. Alternatively, daylight saving time adjustments in the master geo-political region occur during the time not covered by the defined time block. In some embodiments of the invention, daylight saving time adjustments in the slave geo-political region occur during the time covered by the defined time block. Alternatively, daylight saving time adjustments in the slave geo-political region occur during the time not covered by the defined time block. In some embodiments of the invention, the time block can be used to scroll through all of the days in the calendar. Optionally, the time block displays the existence of an event to all users but displays the details of the event only to specific users. In some embodiments of the invention, the start time per day is the same for all days of the time block. In some embodiments of the invention, the start time per day is different for at least some days of the time block. Optionally, the time block displays a full week of 7 days and 24 hours for each day. Alternatively, the specific number of hours per day is less than 24. Optionally, the specific number of hours per day is different for some of the days. In some embodiments of the invention, the specific number of hours per day is the same for all the days in the time block. Optionally, the time block is defined automatically to wrap around events in the calendar. In some embodiments of the invention. the time block is defined automatically to form a rectangle around events in the calendar.

There is thus additionally provided according to an exemplary embodiment of the invention, a system for displaying a computerized calendar according to different geo-political regions, comprising: a server for executing a computer application, one or more client stations, which are associated with a specific geo-political region and communicate with the server, an application that is programmed to provide a view of the content of the calendar to the one or more client stations, wherein the application is programmed to provide each station with the view of the calendar that is adjusted according to the geo-political region associated with the station; and wherein the geo-political region defines a time zone and a date and time for starting and for ending the implementation of daylight saving time.

There is thus further additionally provided according to an exemplary embodiment of the invention, an application stored on a computer readable storage medium for displaying a computerized calendar according to different geo-political regions, comprising: a daylight saving time rule database to define the dates and times for starting and for ending the implementation of daylight saving time in a specific geo-political region, a conversion engine that is adapted to transform a view of the calendar according to a requested region, and wherein the application is adapted to display for a user the view of the calendar which is adjusted according to a requested geo-political region.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of a system for displaying a calendar based on a selected geo-political region, according to an exemplary embodiment of the invention;

FIG. 2 is a flow diagram of a method of displaying a calendar, according to an exemplary embodiment of the invention;

FIGS. 3A-3D are schematic illustrations of 24×7 hour time block displays showing a slave view relative to a master view of part of a calendar, according to an exemplary embodiment of the invention;

FIGS. 4A-4D are schematic illustrations of 8×7 hour time block displays showing two slave views relative to a master view of part of a calendar. according to an exemplary embodiment of the invention; and

FIGS. 5 is a schematic illustration of an exemplary pair of time blocks showing a master view and a slave view of part of a calendar, according to an exemplary embodiment of the invention.

### DETAILED DESCRIPTION

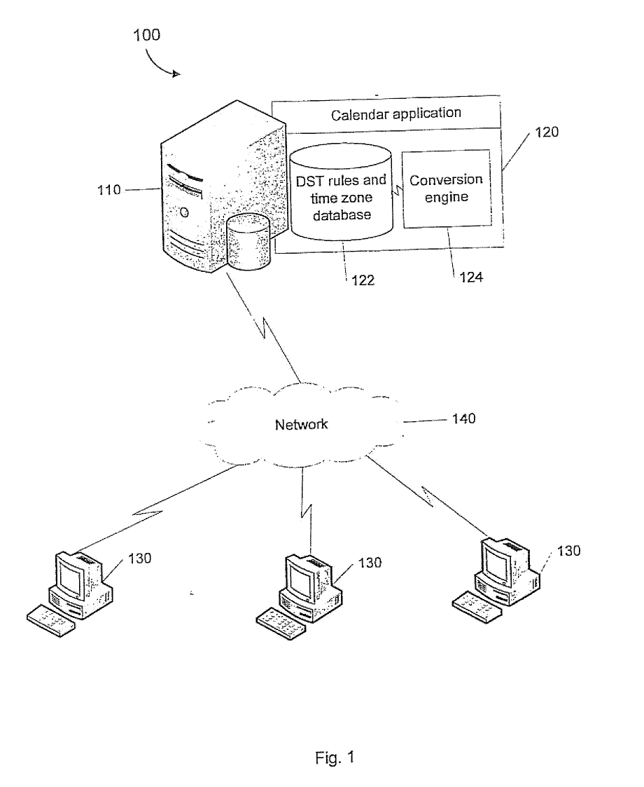

FIG. 1 is a schematic illustration of a system 100 for displaying a calendar based on a selected geo-political region, according to an exemplary embodiment of the invention. In an exemplary embodiment of the invention, system 100 includes a server 110 for executing an application 120 that emulates a calendar. Application 120 provides for display a time block, which may list events scheduled for the time covered by the time block. The time block refers to a window over the calendar covering a selected number of days and a selected number of hours for each day, for example a full week (24 hours times 7 days), or a subset of a week (e.g. 8 hours a day times 5 or 6 days—business hours). In some embodiments of the invention the time block may include a different number of hours for each day. Optionally the time block may be automatically defined by system 100 according to the contents of the calendar to include all or part of the user's events. In some embodiments of the invention the automatically defined time block may form a rectangle around the events defined by the user. Alternatively the time block may form any other shape to provide the minimal block size covering selected events or all of the events.

In an exemplary embodiment of the invention, a user of application 120 can view a time block of his/her calendar according to the time zone and daylight saving status of the geo-political region in which the user is located. In some embodiments of the invention, the user can also view a time block of his/her calendar in a converted form such that the same times and days shown in the user's time block will be displayed according to the respective times in a different geo-political region, which may differ by the start and end date of daylight saving and/or time zone (i.e. hour relative to GMT (Greenwich Mean Time)). This option enables a user to determine the differences between times in his/her geo-political region and other geo-political regions, so that the user may take the differences into account and notify people in other countries and regions regarding the differences, for example the local time for the occurrence of a scheduled event. In some embodiments of the invention, each time block is displayed on a display separately. Alternatively, a pair of time blocks or even more than two time blocks representing a view of the user's calendar according to different geo-political regions may be shown simultaneously on the same display to allow the user to readily see the difference between the time according to different geo-political regions.

In some embodiments of the invention, more than one calendar is involved wherein calendar sharing or a relationship between them is of interest, for example wherein each user has their own calendar and they are interested in coordinating an event between them. As explained above one calendar (e.g. the calendar of the person initiating the scheduling) is referred to as the master calendar and the other calendars have a slave relationship relative to the master calendar.

In an exemplary embodiment of the invention, the slave views of the time block show the same number of hours as the master view of the time block, according to the time in their region, for example if the first column in the master region time block starts at 09:00 on Sunday and has 8 hours the slave view of the time block will show in its first column the time which corresponds to the start time in the master region and will have the same number of hours as in the master region. In some cases various days during the time block may have 23 hours or 25 hours in one or more of the regions thus complicating the transformation of the time block display according to each region.

In some embodiments of the invention, server 110 is connected to a network 140, for example over an intranet or over the Internet. Optionally, one or more client stations 130 may access application 120 to view their calendars according to their geo-political region or in converted form according to a different geo-political region. In some embodiments of the invention, a user may permit access to his/her calendar so that other users may view his/her calendar according to their geo-political time zone. This option enables a user to locate available times according to the calendars of other people (e.g. co-workers) in order to schedule a meeting. Optionally, the details of the events in another person's calendar may be concealed and the user may only be able to see if a specific time is occupied or not.

In an exemplary embodiment of the invention, application 120 is accessible by a general purpose web browser, for example Microsoft Internet Explorer™ or other standard browsers. Alternatively or additionally, application 120 may be provided as a dedicated program or may be provided as a part of a different application, for example a scheduling program. Optionally, application 120 provides the incorporating application with the ability to convert the display of a time block according to the required geo-political region as described below. In an exemplary embodiment of the invention, application 120 comprises a database 122, which stores daylight saving time rules and time zone information for the use of application 120. Additionally, application 120 comprises a conversion engine 124, which incorporates the rules and converts the display of a time block from the master geo-political region display to a slave geo-political region display. Conversion engine 124 may be implemented to display multiple views of a time block of an independent calendar according to different geo-political regions. Additionally, conversion engine 124 may be implemented to convert the display of a time block of a master calendar in one geo-political region to the display according to a slave calendar in a different geo-political region.

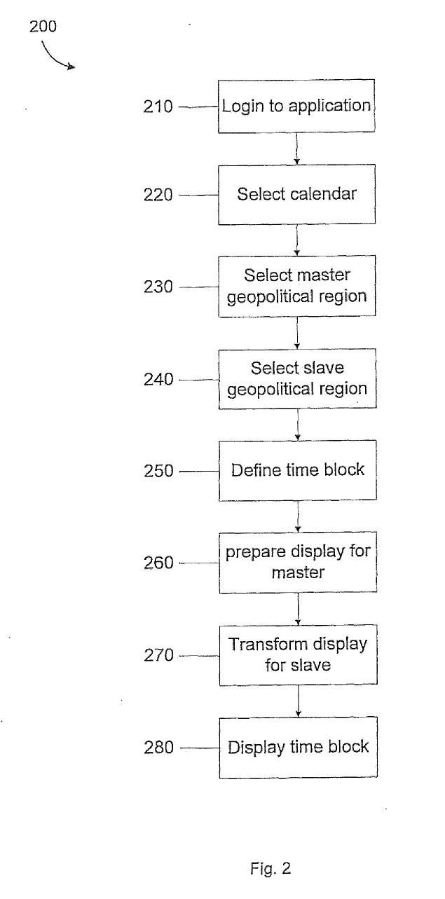

FIG. 2 is a flow diagram of a method 200 of displaying a calendar, according to an exemplary embodiment of the invention. In an exemplary embodiment of the invention, application 120 provides each user with a personal calendar. Optionally, a user performs a login (210) to identify himself/herself to application 120, so that application 120 can retrieve the user's personal information, for example the user's calendar from database 122. After logging in the user can select (220) to view his/her calendar as an independent calendar according to different geo-political regions. Alternatively, the user may view his/her calendar as related to another calendar (e.g. a slave view). In some embodiments of the invention, the user can view another user's calendar as an independent calendar if given permission by the other user, for example a user can allow specific users or groups of users to view his/her calendar (e.g. co-workers or the boss) or can allow all users to view his/her calendar. Optionally, a user may allow others to view only specific items in his/her calendar or may limit the view by others only to the existence of an event but not to the details recorded.

In an exemplary embodiment of the invention, the user selects (230) the master geo-political region, which is generally selected to be the region where the owner of the calendar resides. Optionally, the user then selects (240) a slave geo-political region, which is the region by which the user wishes to view the calendar. In an exemplary embodiment of the invention, the user defines (250) the number of days and which hours of the day will be shown by the time block. Optionally, system 100 plans (260) the display of the defined time block according to the master geo-political region, which is generally a straight forward display of the contents of the calendar with minimal adjustments for days with skipped hours (23 hours) and days with extra hours (25 hours). In an exemplary embodiment of the invention, system 100 transforms (270) the display of the time block according to the master region to a display according to the slave geo-political region. The transformation includes adjustments to the indexes of the displayed time block and blocking out of areas so that the same number of hours shown according to the master geo-political region is shown with the correct local time and days according to the slave geo-political region as exemplified below.

In an exemplary embodiment of the invention, application 120 transforms the contents of the calendar and displays (280) a time block with the contents of the calendar for the user to view according to his/her geo-political region relative to the master geo-political region. Optionally, the user is given the option to scroll forward and back through the calendar while viewing one or more time blocks at a time.

In some embodiments of the invention, a single time block is displayed for the user, showing the transformed form of the time block from the calendar (transformed to the view according to a slave geo-political region). Alternatively, pairs of time blocks may be displayed, showing a time block according to the master geo-political region and the slave geo-political region on the same display to simplify comparison between the two.

Optionally, a user may select to view a calendar with the owner's region serving as the master geo-political region and the user's region serving as the slave geo-political region or vice-versa, wherein the user's region serves as the master geo-political region and the owner's region serves as the slave geo-political region for viewing a time block of the calendar.

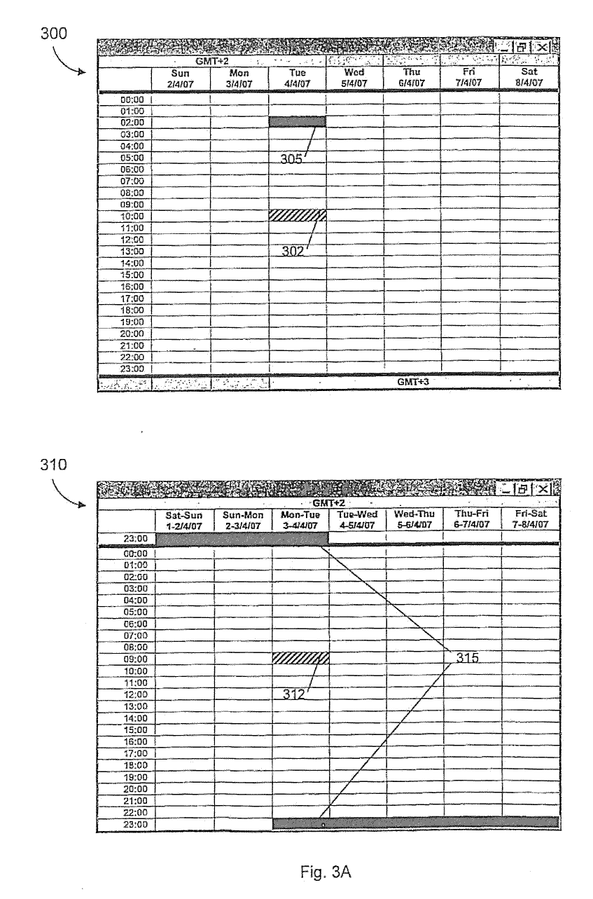

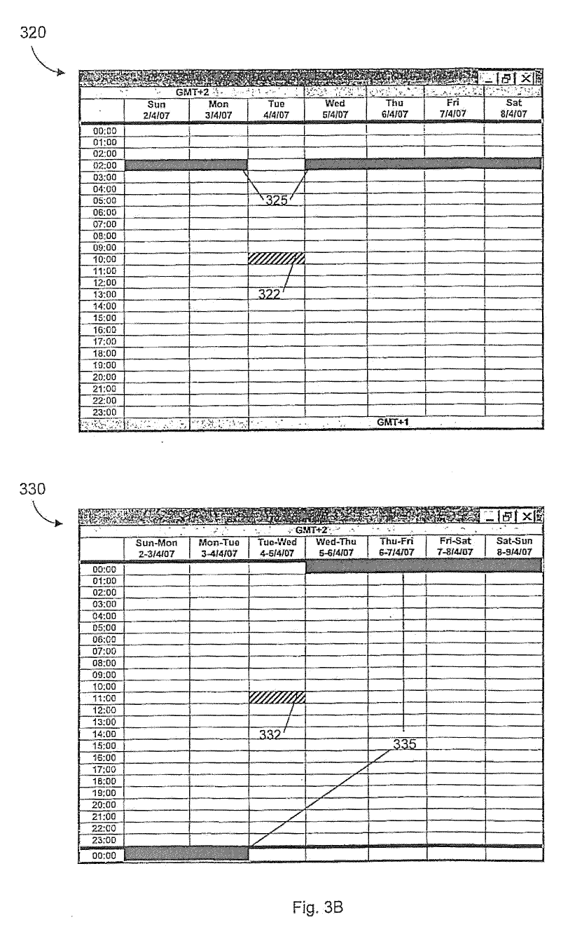

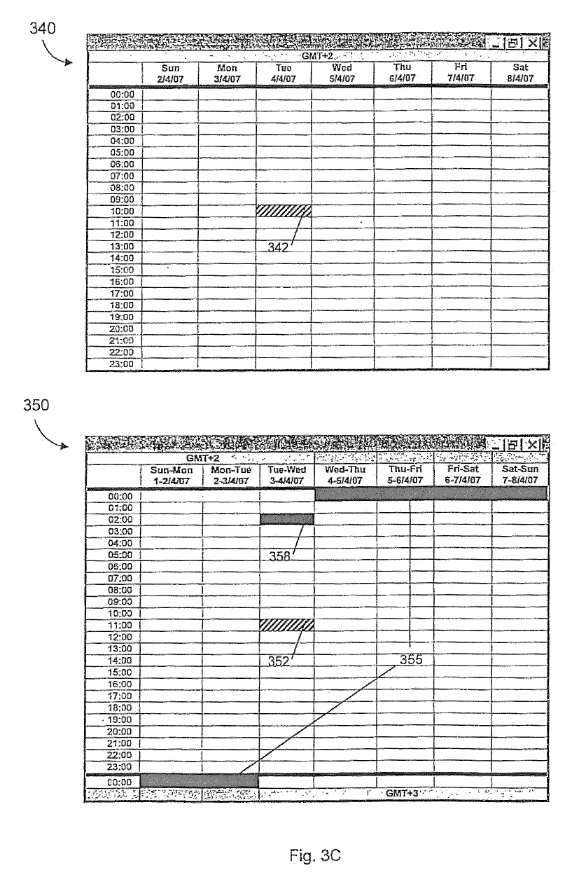

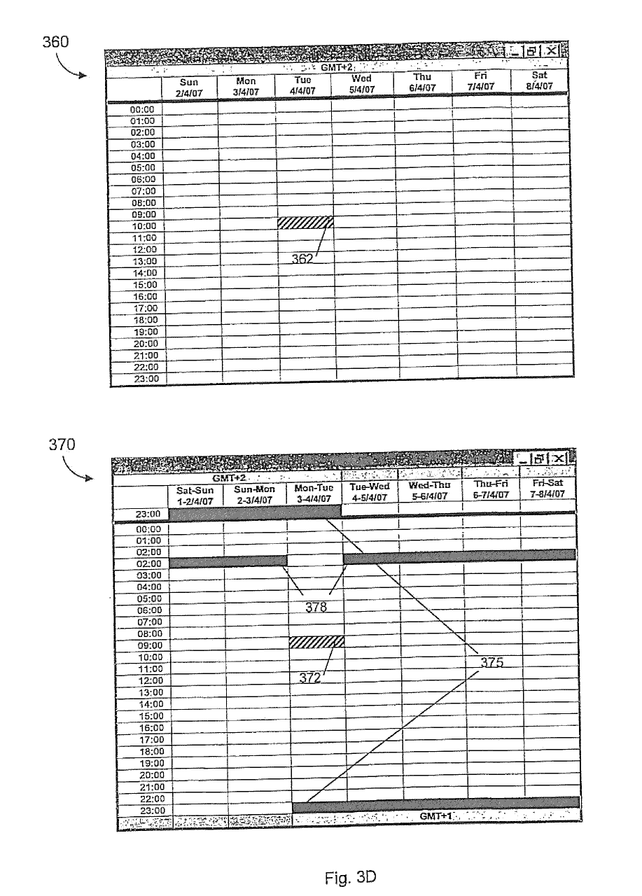

FIGS. 3A-3D are schematic illustrations of 24×7 hour time block displays showing a slave view relative to a master view of part of a calendar, according to an exemplary embodiment of the invention. The time blocks in FIGS. 3A-3D show four basic cases, namely:

1. Skipping an hour only in the master geo-political region (FIG. 3A).

2. Repeating an hour only in the master geo-political region (FIG. 3B).

3. Skipping an hour only in the slave geo-political region (FIG. 3C).

4. Repeating an hour only in the slave geo-political region (FIG. 3D).

The transformation process can be viewed as essentially comprising two steps: first transforming the view of the time block; and then placing any events, which are listed in the master view time block to occur at the corresponding hour in the slave view of the time block.

Optionally, the transformation process is performed by transforming each column of the master time block to a corresponding column of the slave time block, which displays the same start hour and same number of hours as the master column with the correct indexes according to the slave region. Once the slave view of the column is created an event in the slave view can be placed at the same offset by number of hours as in the column in the master view. In some embodiments of the invention, the master calendar can be updated to record events listed in a slave calendar, for example to implement an automatic calendar synchronization mechanism between two or more specific users.

FIG. 3A shows two time blocks (300, 310) of a fall week from a user's calendar according to a master view and a slave view respectfully, according to an exemplary embodiment of the invention. On Tuesday of the week displayed daylight saving time (DST) comes into effect at 02:00 in the master's geo-political region so that 02:00 is skipped and Tuesday only has 23 hours. In time block 300 02:00 is blocked by blacked out area 305 to represent the skipped hour. It should be noted that after DST came into effect, time block 300, which was originally at GMT+2 became a region with GMT+3, as marked in time block 300. Additionally, time block 300 shows an event scheduled on Tuesday from 10:00-11:00 after the time adjustment and marked as area 302.

Time block 310 shows the same week with the corresponding hours and the same number of hours as shown by time block 300, but according to a slave view in the same time zone (GMT+2) as the master. Time block 310 shows the week starting from 23:00 of the day before in order to be able to show the same actual hours each day as shown in time block 300. In time block 310 area 315 is blacked out to leave active only the area which corresponds to the times in time block 300. The first two columns of time block 310 have the same hours as time block 300. The third column has 23 hours like in the master display causing a shift in the proceeding columns. The fourth, fifth, sixth and seventh columns of time block 310 begin on the day before at 23:00 and the last hour of each day is 22:00 in order to correspond to the columns shown in time block 300. This occurs since the master region is now GMT+3 whereas the slave region remains GMT+2. The event on Tuesday occurs at 09:00 (area 312) in the slave region instead of occurring at 10:00 as in the master region as a result of the skipped hour in the master region.

FIG. 3B shows two time blocks (320, 330) of a full week from a user's calendar according to a master view and a slave view respectfully, according to an exemplary embodiment of the invention. On Tuesday of the week displayed daylight saving time (DST) ends at 02:00 in the master's geo-political region so that the 02:00 hour is repeated and Tuesday has 25 hours. In time block 320 the hour index on the left shows two 02:00 hours, but the second 02:00 hour is blocked out by area 325 in all the columns of the time block except Tuesday when the hour is repeated. It should be noted that after DST ends, time block 320, which was originally at GMT+2 became a region with GMT+1, as marked in time block 320. Additionally, time block 320 shows an event scheduled on Tuesday from 10:00-11:00 after the time adjustment, and marked as area 322.

Time block 330 shows the same week with the corresponding hours and the same number of hours shown by time block 320 but according to a slave view in the same time zone (GMT+2) as the master. Time block 330 shows the week with columns starting as in time block 320 from 00:00 each day but ending at 00:00 of the next day in order to be able to show the same actual hours each day as shown in time block 320. In time block 330 area 335 is blacked out to leave active only the area which corresponds to the times in time block 320. The first two columns of time block 330 have the same hours as time block 320. Tuesday contains another hour due to the repetition in the master region so the last hour on Wednesday is 00:00. The fourth, fifth, sixth and seventh columns of time block 330 begin at 01:00 on the day and the last hour is 00:00 of the next day in order to correspond to the columns shown in time block 320. This occurs since the master region has become GMT+1 whereas the slave region remains GMT+2. The event on Tuesday occurs at 11:00 (area 332) in the slave region instead of occurring at 10:00 as in the master region.

FIG. 3C shows two time blocks (340, 350) of a full week from a user's calendar according to a master view and a slave view respectfully, according to an exemplary embodiment of the invention. The master time block has no daylight saving events requiring time adjustments, thus it is represented by a complete block comprising 7 columns of 24 hours. Time block 340 is in a region with GMT+2 for the entire block. An event scheduled on Tuesday from 10:00-11:00 is marked in time block 340 as area 342.

Time block 350 shows the same week with the corresponding hours and the same number of hours shown by time block 340 but according to a slave view originally in the same time zone (GMT+2) as the master. Additionally, on Tuesday at 02:00 daylight saving time comes into effect in the region of the slave so 02:00 is blacked out and marked as area 358 since 02:00 does not exist on that day in the slave region. Time block 350 shows the week starting from 00:00 of each day with 00:00 of the next day as the last hour in order to be able to show the same actual hours each day as shown in time block 340. In time block 350 area 355 is used to black out specific times and leave active only the area which corresponds to the times in time block 340. The first two columns of time block 350 have the same hours as time block 340. The third column has only 23 hours in the slave region thus one hour is pulled over from the following day to match the 24 hours in the master display. The fourth, fifth, sixth and seventh columns of time block 350 begin at 01:00 of the day and their last hour is 00:00 of the next day to correspond to the time in the master region since the master region is GMT+2 throughout the time block whereas the slave region changes from GMT+2 to GMT+3. Event 342 on Tuesday is marked as area 352 and occurs at 11:00 in the slave region instead of occurring at 10:00 as in the master region as a result of the skipped hour in the slave region.

FIG. 3D shows two time blocks (360, 370) of a full week from a user's calendar according to a master view and a slave view respectfully, according to an exemplary embodiment of the invention. The master time block 360 has no daylight saving events requiring time adjustments, thus it is represented by a complete block comprising 7 columns of 24 hours. Time block 360 is in a region with GMT+2 for the entire block. An event scheduled on Tuesday from 10:00-11:00 is marked in time block 360 as area 362.

Time block 370 shows the same week with the corresponding hours and the same number of hours shown by time block 360 but according to a slave view originally in the same time zone (GMT+2) as the master. Additionally, on Tuesday at 02:00 daylight saving time ends in the region of the slave so 02:00 is repeated on that day resulting in a day of 25 hours. The time index in time block 370 has 02:00 twice in order to show the repeated hour on Tuesday. On the other days of the week the second 02:00 is blacked out by area 378 since they only have one 02:00 hour. Time block 370 shows the week starting from 23:00 of the day before each day and the last hour is 23:00 in order to be able to show the same actual hours each day as shown in time block 360. In time block 370 area 375 is used to black out specific times and leave active only the area which corresponds to the times in time block 360. The first two columns of time block 370 have the same hours as time block 360. The third column needs to show a repeated hour (02:00) in the slave region but yet maintain 24 hours as in the master view of the column, thus one hour (23:00-0:00) is pushed over to the column of the following day to match the 24 hours in the master display. The fourth, fifth, sixth and seventh columns of time block 370 begin at 23:00 of the previous day with 22:00 as the last hour of the day in order to correspond to the time in the master region since the master region is GMT+2 throughout the time block whereas the slave region changes from GMT+2 to GMT+1 after ending DST on Tuesday. Event 362 on Tuesday is marked as area 372 and occurs at 09:00 in the slave region instead of occurring at 10:00 as in the master region as a result of the repeated hour in the slave region.

In an exemplary embodiment of the invention, more complex cases may occur based on the cases shown by FIGS. 3A-3D by combining the case occurring in the master region with the case occurring in the slave region, namely the following cases may occur:

1. A skipped hour in the master region and a skipped hour in the slave region.

2. A skipped hour in the master region and a repeated hour in the slave region.

3. A repeated hour in the master region and a skipped hour in the slave region.

4. A repeated hour in the master region and a repeated hour in the slave region.

Additionally, the DST change can take place at the same hour for both the master and the slave or the change may take place at different hours and/or different days in the master region relative to the slave region. Generally, the same methods as shown above will be used to accommodate these changes separately or in combination. Optionally, the master region is shown with minimal adjustments, whereas the slave region is adjusted to match the time block shown for the master region by displaying the same hours whenever they occur.

In some embodiments of the invention, the user can define the boundaries of the time block that is displayed to the user. The boundaries include the number of days displayed by a time block and a specific starting hour and number of hours per day to be displayed. Optionally, instead of the user viewing full days the user may view specific hours of interest, for example the hours corresponding to the work day in the master region.

In an exemplary embodiment of the invention, the number of hours shown in the time block may be any value, for example 4, 7, 8, 10, 11, 12 or even 13. Additionally, the unit displayed in the time chart may be different than 1 hour, for example half an hour or a third of an hour to accommodate countries which adjust their clocks for daylight saving time by less than an hour (e.g. ½ an hour), or for countries, which adjust their clocks to be offset relative to GMT by a non-integer.

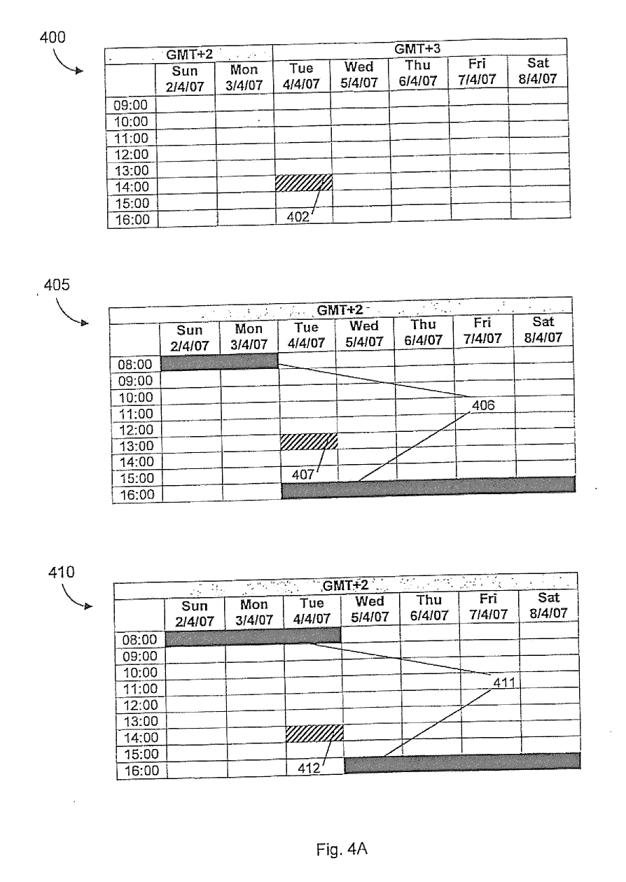

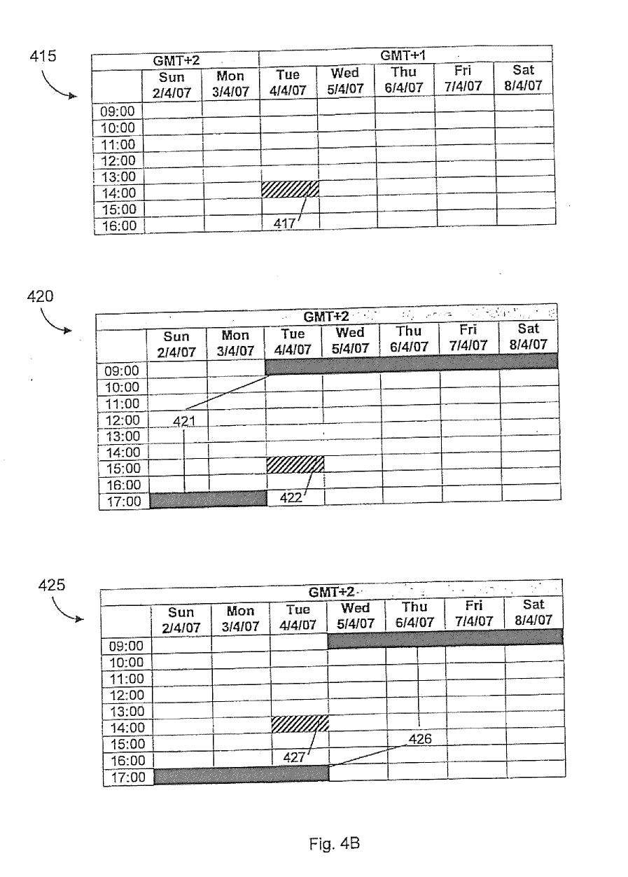

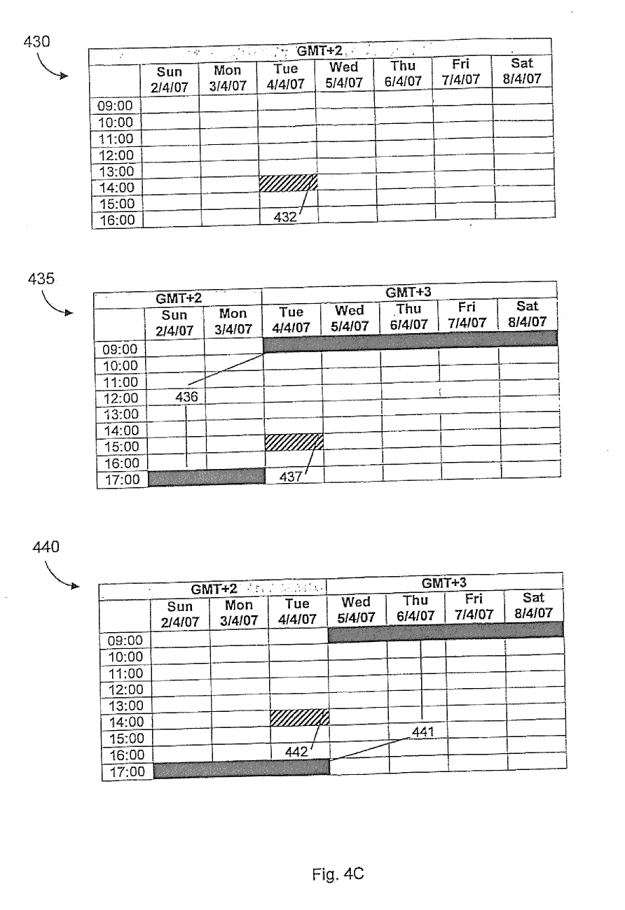

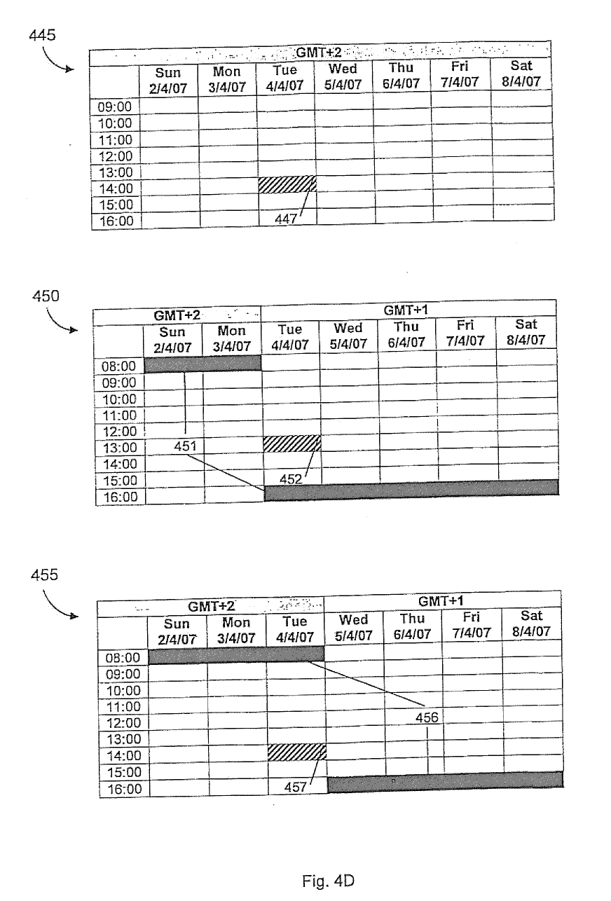

FIGS. 4A-4D are schematic illustrations of 8 hour×7 day time block displays showing two slave views relative to a master view of part of a calendar, according to an exemplary embodiment of the invention.

In FIGS. 3A-3D the entire day was displayed and the DST time change had to occur during the hours covered by the time block. In contrast, in FIGS. 4A-4D only part of the day is shown by the time block and the DST time change may occur on a specific day before or after the time shown by the time block. In FIGS. 4A-4D similar considerations are applied as described above regarding FIGS. 3A-3D. The description below will point out the main features of FIGS. 4A-4D and important differences relative to FIGS. 3A-3D.

FIG. 4A shows an 8 hour time block 400 with a view according to the master region with a skipped hour (starting DST) occurring on Tuesday before the time of day shown in the time block, for example at 02:00. The skipped hour before the beginning of the time block on Tuesday causes the time zone to change from GMT+2 to GMT+3. Area 402 shows an event scheduled for 14:00 on Tuesday.

Time block 405 shows a slave view of time block 400. Area 406 is blacked out and area 407 shows the scheduled event occurring at 13:00 on Tuesday as a result of the skipped hour before the time of the time block (e.g. at 02:00).

Time block 410 shows a slave view of master time block 400 as if the skipped hour had occurred on Tuesday after the time shown by the time block for example at 23:00. Area 411 is blacked out to match the time represented by time block 400 and area 412 shows the scheduled event occurring at 14:00 like in time block 400 since the time change occurred only later in the day.

FIG. 4B shows an 8 hour time block 415 with a view according to the master region with a repeated hour (ending DST) occurring on Tuesday before the time of day shown in the time block, for example at 02:00. The repeated hour before the beginning of the time block on Tuesday causes the time zone to change from GMT+2 to GMT+1. Area 417 shows an event scheduled for 14:00 on Tuesday.

Time block 420 shows a slave view of time block 415. Area 421 is blacked out and area 422 shows the scheduled event occurring at 15:00 on Tuesday as a result of the repeated hour occurring before the time of the time block (e.g. at 02:00).

Time block 425 shows a slave view of master time block 400 as if the repeated hour had occurred on Tuesday after the time shown by the time block for example at 23:00. Area 426 is blacked out to match the time represented by time block 400 and area 427 shows the scheduled event occurring at 14:00 like in time block 415 since the time change occurred only later in the day.

FIG. 4C shows an 8 hour time block 430 with a view according to the master region without any time adjustments in the master region. Area 432 shows an event scheduled for 14:00 on Tuesday.

Time block 435 shows a slave view of time block 430 in a case that there is a skipped hour on Tuesday in the slave's region before the time showed by time block 435. Blacked out area 436 shows amendments to time block 435 so that it corresponds to time block 430. Area 437 shows the scheduled event occurring at 15:00 on Tuesday as a result of the skipped hour in the slave region before the time of the time block (e.g. at 02:00).

Time block 440 shows a slave view of master time block 430 in the case that the skipped hour in the slave region occurred on Tuesday after the time shown by the time block for example at 23:00. Area 441 is blacked out to correspond to the time represented by time block 430 and area 442 shows the scheduled event occurring at 14:00 like in time block 430 since the time change occurred only later in the day.

FIG. 4D shows an 8 hour time block 445 with a view according to the master region without any time adjustments in the master region. Area 447 shows an event scheduled for 14:00 on Tuesday.

Time block 450 shows a slave view of time block 445 in a case that there is a repeated hour (DST ends) on Tuesday in the slave's region before the time showed by time block 450. Blacked out area 451 shows amendments to time block 450 so that it corresponds to time block 445. Area 452 shows the scheduled event occurring at 13:00 on Tuesday as a result of the repeated hour in the slave region occurring before the time of the time block (e.g. at 02:00).

Time block 455 shows a slave view of master time block 445 in the case that the skipped hour in the slave region occurred on Tuesday after the time shown by the time block for example at 23:00. Area 456 is blacked out to correspond to the time represented by time block 445 and area 457 shows the scheduled event occurring at 14:00 like in time block 445 since the time change occurred only later in the day.

As mentioned above regarding 24 hour time blocks, also for partial day time blocks various combinations of regions with DST starting and DST ending (skipped hours and repeated hours) may occur resulting in adjustments to the display area of the time block and to the scheduled events occurring inside the block according to different views described and exemplified above.

Optionally, the following parameters and any combination of them may affect the display of a time block in the master region and in the slave region:

1. A DST change in the master region (repeated hour or skipped hour).

2. A DST change in the slave region (repeated hour or skipped hour).

3. A DST change occurring inside the time block.

4. A DST change occurring outside the time block (before or after the time block).

In an exemplary embodiment of the invention, complex time blocks may occur as a result of combinations of the above cases, for example daylight saving time adjustments may occur in the master region and in the slave region on the same day or on different days and in the same or different hour. In some embodiments of the invention, one region may be starting DST while the other is ending DST during the same time block. Additionally, the daylight saving time adjustments may occur in addition to time zone adjustments causing the times and days in a slave region to be shifted relative to the master region.

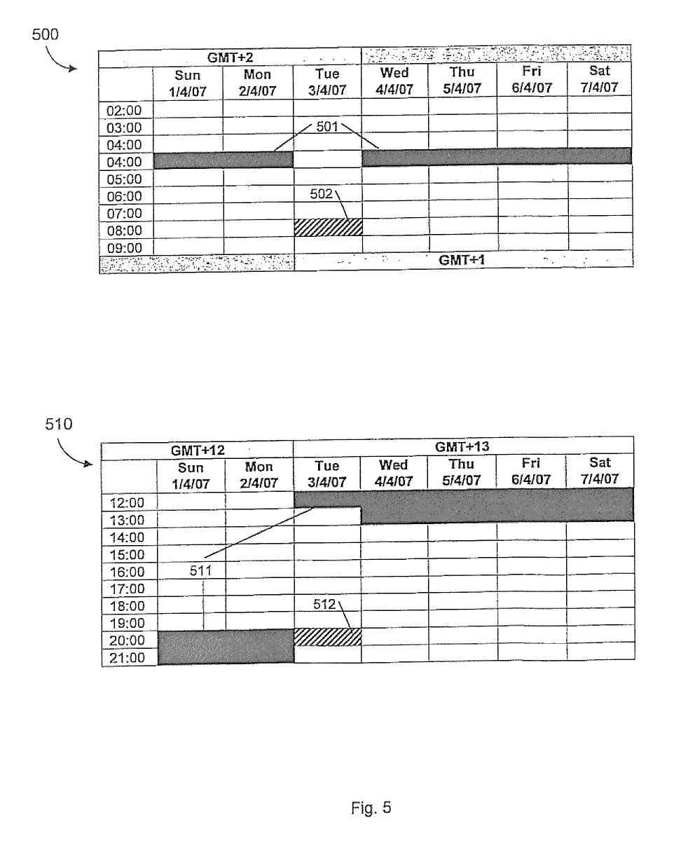

FIG. 5 is a schematic illustration of an exemplary pair of time blocks (500, 510) showing a master view and a slave view of part of a calendar, according to an exemplary embodiment of the invention. Time block 500 is a master region view showing 7 days between 02:00 to 10:00 (8 hours per day). On Tuesday there is a repeated hour due to DST ending at 04:00, so the hour index has two 04:00 hours, which are blacked out by area 501 for all the days of the week except Tuesday. Tuesday has 9 hours since the clock was moved back at 04:00, so 04:00 occurred twice. In the beginning of the time block the time zone was GMT+2, but after Tuesday at 04:00 it became GMT+1. Time block 500 shows an event that occurs at 08:00 on Tuesday (marked by area 502), which is after the time change came into effect.

Time block 510 is a slave region view, which needs to show the same 57 hours (7×8+1) as in time block 500. Each day in time block 510 starts at the hour corresponding to the start hour in time block 500 and the day has the same amount of hours. Time block 510 is initially of a time zone of GMT+12 so that Sunday at 02:00, which is the first hour of time block 500 becomes Sunday at 12:00 in time block 510. On Tuesday at 02:00 DST starts, causing an hour to be skipped in the slave region, which further complicates the conversion between the times appearing in the master region time block 500 and the times appearing in the slave region time block 510. After the skipped hour the slave region becomes GMT+13. In order to match the hours of time block 500, time block 510 shows times from 12:00 with the last hour being 21:00 (10 hours), since the last hour of time block 500 (09:00-10:00) becomes 21:00-22:00 in time block 510. Blacked out area 511 shows times which are outside of time block 500 and have been blacked out in time block 510. The event shown by area 502 in time block 500 at the eighth hour of the day occurs in time block 510 (shown by area 512) at 20:00, which is also the eighth hour of the day in correspondence with time block 500. As a result of DST ending in the master region and DST starting in the slave region the time zone gap between the master and slave grows from initially being 10 hours (12−2) to 12 hours (13−1). It should be noted that all of the days in both time blocks 500 and 510 have 8 hours except Tuesday which has 9 hours according to the time adjustment in the master region, thus both blocks have 57 hours.

In a similar manner other pairs of master and slave views can be shown. It should be noted that there are a few hundred (currently about 500) different geo-political regions, each with different dates and times for implementing DST and in different time zones. During the period that regions in the northern hemisphere of the earth will be starting DST, regions in the southern hemisphere of the earth will be ending DST and vice versa, thus many complex situation may arise and are handled by application 120.

In some embodiments of the invention the method of display of the time block may vary, for example by displaying the content of the time block as a single horizontal line instead of a two dimensional block.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

1. A method of displaying a computerized calendar according to different geo-political regions, comprising:
selecting a master geo-political region as a base for the display of the contents of the calendar;
defining a time block that serves as a window for viewing the contents of the calendar; wherein said time block is defined by a selected number of days, a specific number of hours per day, and a start time per day;
retrieving the contents of the calendar for the time defined by the time block starting from a selected date;
selecting a slave geo-political region for displaying the contents of the calendar according to it;
planning the display of the time block according to the master geo-political region;
transforming the planned time block display according to the slave geo-political region; wherein said transformation takes into account clock differences between the master geo-political region and the slave geo-political region, which include differences in start date and end date of implementing daylight saving time in the geo-political region, and differences in the time zone of the geo-political region; and
displaying the transformed display.

2. A method according to claim 1, wherein said time block is displayed according to the master geo-political region and the slave geo-political region on the same display simultaneously.

3. A method according to claim 1, wherein a single user can view the time block according to multiple regions.

4. A method according to claim 1, wherein each user is displayed the time block only according to a region associated with user.

5. A method according to claim 1, wherein said transformed display shows the same number of hours as the planned master display.

6. A method according to claim 1, wherein daylight saving time adjustments in the master geo-political region occur during the time covered by said defined time block.

7. A method according to claim 1, wherein daylight saving time adjustments in the master geo-political region occur during the time not covered by said defined time block.

8. A method according to claim 1, wherein daylight saving time adjustments in the slave geo-political region occur during the time covered by said defined time block.

9. A method according to claim 1, wherein daylight saving time adjustments in the slave geo-political region occur during the time not covered by said defined time block.

10. A method according to claim 1, wherein said time block can be used to scroll through all of the days in said calendar.

11. A method according to claim 1, wherein said time block displays the existence of an event to all users but displays the details of the event only to specific users.

12. A method according to claim 1, wherein the start time per day is the same for all days of the time block.

13. A method according to claim 1, wherein the start time per day is different for at least some days of the time block.

14. A method according to claim 1, wherein said time block displays a full week of 7 days and 24 hours for each day.

15. A method according to claim 1, wherein said specific number of hours per day is less than 24.

16. A method according to claim 1, wherein said specific number of hours per day is different for some of the days.

17. A method according to claim 1, wherein said specific number of hours per day is the same for all the days in the time block.

18. A method according to claim 1, where the time block is defined automatically to wrap around events in the calendar.

19. A method according to claim 1, where the time block is defined automatically to form a rectangle around events in the calendar.

20. A system for displaying a computerized calendar according to different geo-political regions, comprising:
a server for executing a computer application;
one or more client stations, which are associated with a specific geo-political region and communicate with the server;
an application that is programmed to provide a view of the content of the calendar to the one or more client stations;
wherein said application is programmed to provide each station with the view of the calendar that is adjusted according to the geo-political region associated with the station; and
wherein said geo-political region defines a time zone and a date and time for starting and for ending the implementation of daylight saving time.

21. An application stored on a computer readable storage medium for displaying a computerized calendar according to different geo-political regions, comprising:
a daylight saving time rule database to define the dates and times for starting and for ending the implementation of daylight saving time in a specific geo-political region:
a conversion engine that is adapted to transform a view of the calendar according to a requested region; and
wherein said application is adapted to display for a user the view of the calendar which is adjusted according to a requested geo-political region.
